(19) United States
(12) Patent Application Publication
(10) Pub. No.: US 2005/0040054 A1
(43) Pub. Date: Feb. 24, 2005

(54) DISPENSING AID FOR ADMINISTERING MEDICATIONS TO INFANTS.

(76) Inventor: ERIK JON PETERSON, GRAYSLAKE, IL (US)

Correspondence Address: NOVEL IDEAS INC, 1117 SILO HILL DRIVE, GRAYSLAKE, IL, 60030, US

(21) Appl. No.: 10/710,606

(22) Filed: Jul. 23, 2004

Related U.S. Application Data
(63) Continuation-in-part of application No. 10/604,824, filed on Aug. 20, 2003.

(51) Int. Cl. A61J 17/00; B65D 25/08

(52) U.S. Cl. 206/219; 604/77

(57) ABSTRACT

The present invention relates to a dispensing device for administering medication(s) to infants, in particular a plastic insert that is used with a baby nipple and bottle so that the medication is held separate from the food until mixed with formula or breast milk and administered through the nipple with the first portion of an infants feeding. The device may comprise a coned shaped insert or duck bill insert that provides a liquid tight seal along the perimeter of contact of the insert and nipple. The insert may comprise an upper and lower chamber so that the medication is contained in the upper chamber and the formula or breast milk is contained in the lower chamber. Furthermore, the insert may comprise an inlet port and an outlet port so that formula or breast milk can flow from the lower chamber into the upper chamber for mixing and administering.

### BACKGROUND OF INVENTION

1. Field of the Invention

The present invention relates to a liquid medication dispensing device for administering medication(s) to infants, in particular a plastic insert that is used with a standard baby nipple and bottle so that the medication is mixed with liquid infant food and administered through the nipple during the first portion of an infants feeding.

There is often a need to administer medication(s) to infants under the age of 1 year old, specifically to administer said medication(s) simultaneously and mixed with an infants formula or breast milk during feeding. This need arises because an infant is more likely to ingest the medication(s) if said medication(s) is mixed with breast milk or formula, especially if said medication(s)/food mixture is administered through a nipple.

There are several advantages in administering medication(s) if medication(s) is mixed with formula or breast milk or other liquid food and administered through a nipple. Medication(s) administered directly is often rejected by the infant for many reasons; including flavor, temperature and/or consistency. Furthermore, infant habits of ingesting food (or medicine) via spoon, dropper or syringe are not fully developed resulting in the infant rejecting the dose. In return, caretakers will mix medication(s) with formula or breast milk during feeding. This can make it difficult to determine how much medication has been administered. A typical feeding can be 2-8 ounces and it is not uncommon for the infant to stop feeding before the entire feeding is consumed or for the infant to “spit up” the last portion of the feeding.

Furthermore, there is a cost advantage if standard nipples and bottles are used as an integral part of the liquid medication dispensing device. This eliminates the expense of purchasing a specialized feeding system that is only used for administering liquid medication(s).

2. Description of the Prior Art

The prior art describes several liquid medication dispensers that attempt to resolve these problems. For example, Burchett et al, U.S. Pat. Nos. 5,383,906 and 5,487,750 and 5,824,012 and 6,200,295B1 describe a liquid medication dispenser that includes a nursing bottle, syringe and nipple as a complex assembly. Medication must be continuously feed into the nipple via the syringe which could cause poor mixing of medication and formula. Furthermore, this device has several components which make it difficult to clean and expensive to produce. Finally, the Burchett patents do not insure that the medication will be administered during the initial portion of the feeding, making it difficult to determine how much medication has been administered in the event that the infant spits up near the end of feeding as is typical.

Botts, U.S. Pat. No. 6,270,519B1 teaches a similar device to Burchett et al that includes a complete bottle, nipple, syringe assembly. The Botts patent does not achieve mixing of food and medication.

Martin, U.S. Pat. No. 5,129,532 teaches a specially designed nipple that includes a sealed upper and lower housing with an inlet in the lower housing for inserting medication into the interior of the device. The upper portion being a nipple design. This does not accommodate for mixing with food via a bottle.

Liu et al, U.S. Pat. No. 5,353,964 teaches a twin bottle with a slidable shutter for controlling the flow of two liquids from two separate containers disposed inside each other. This device is not suited for administering small doses of medication because the medication will tend to adhere to the side walls of the container making it very difficult to insure proper dosing.

There are several other patents that include exterior dispensing devices such as syringes or droppers requiring the user to inject the medication during feeding. These include Lemmons U.S. Pat. No. 4,493,348, Krammer, U.S. Pat. No. 2,680,441 and Roskilly, U.S. Pat. No. 4,821,895. None of these patents provide for use of an inexpensive insert that is used with a standard nipple and bottle for administering liquid medication mixed with infant food during the initial portion of the infants feeding.

### SUMMARY OF INVENTION

The present invention relates to a liquid medication dispensing device for mixing and administering medication(s) with liquid food. The dispensing device of the present invention may comprise a plastic cone shaped insert or duck bill insert. The insert makes mechanical contact with a standard feeding nipple when inserted into said feeding nipple such that the insert forms a liquid seal along the full perimeter of the insert and the nipple. The dispensing device further comprises: a) an inlet port in flow communication with a standard feeding bottle when nipple is turned upside down, as in when used during feeding an infant; b) an outlet port in flow communication with the inlet port when nipple is turned upside down, said inlet port having larger diameter than said outlet port so that formula or breast milk can flow from said bottle to said inlet port and to said outlet port when turned upside down, as in when used during feeding an infant.

When the insert of the liquid medication dispensing device is in mechanical contact with a nipple, said inserted device forms two chambers, (an upper and lower chamber) in said nipple. The upper and lower chambers are in flow communication with each other by means of the inlet and outlet ports of the dispensing device when nipple is turned upside down as in when used during feeding an infant.

### BRIEF DESCRIPTION OF DRAWINGS

FIG. 1 is a cross section view of a preferred embodiment of the invention which illustrates how the invention fits and works with a standard bottle and nipple.

FIG. 2 is a cross section view of the medical nipple dispensing assembly with a cone insert.

FIG. 3 is a front cross section view of a preferred embodiment of the invention shown in feeding orientation depicting how food and medicine flow and mix.

FIG. 4 is a cross section view of a preferred embodiment of the invention.

FIG. 5 is a cross section view of another preferred emodiment of the invention where the insert is a duck bill.

FIG. 6 is a cross section view of the medical nipple dispensing assembly with a duck bill embodiment of the insert.

FIG. 7 is a cross section view of another preffered emodiment of the invention.

### DETAILED DESCRIPTION

As used herein the term “mechanical contact” is used to mean the points at which two or more parts touch each other to form a seal. The term “flow communication” is used to describe the pathway by which the liquid flows within the embodiment of the device. The term “upside down” is used to describe the orientation(s) of a feeding bottle and nipple during use in infant feeding. The term “standard” is used to describe a typical nipple and bottle that is used to feed an infant.

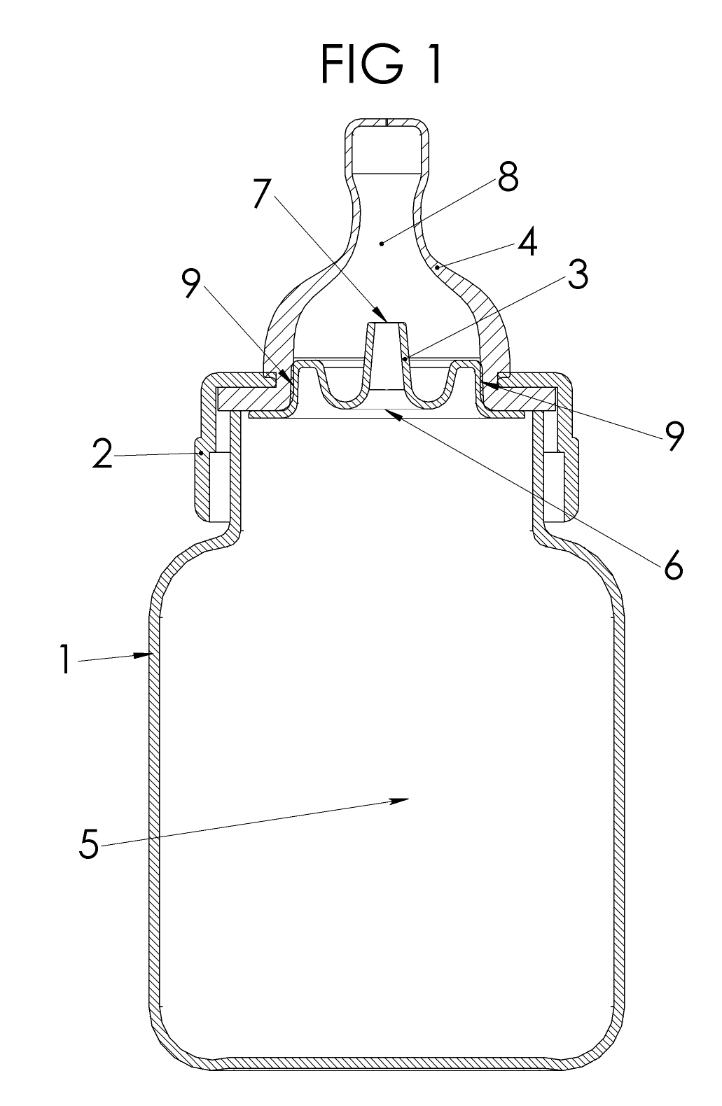

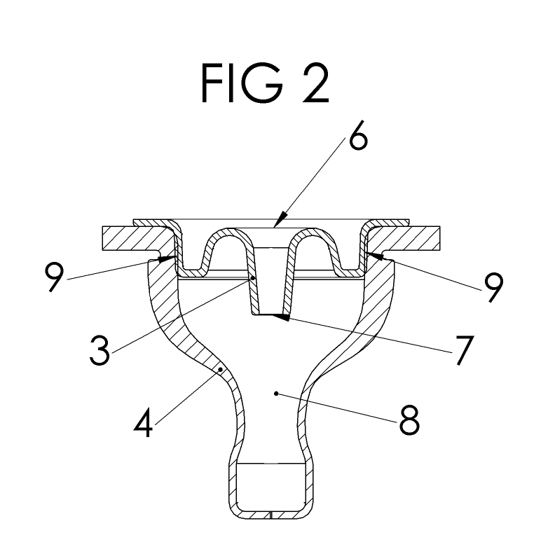

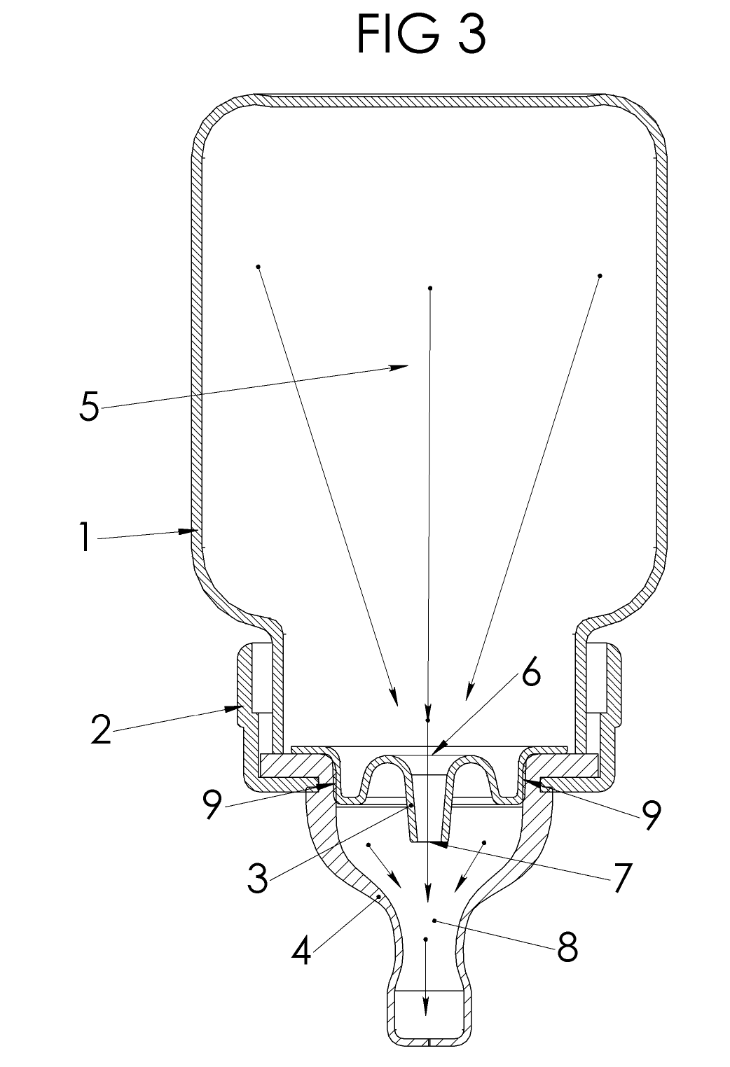

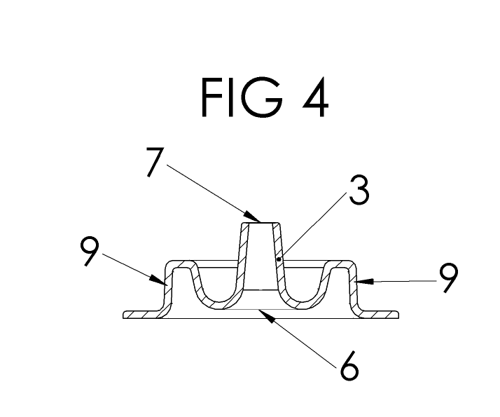

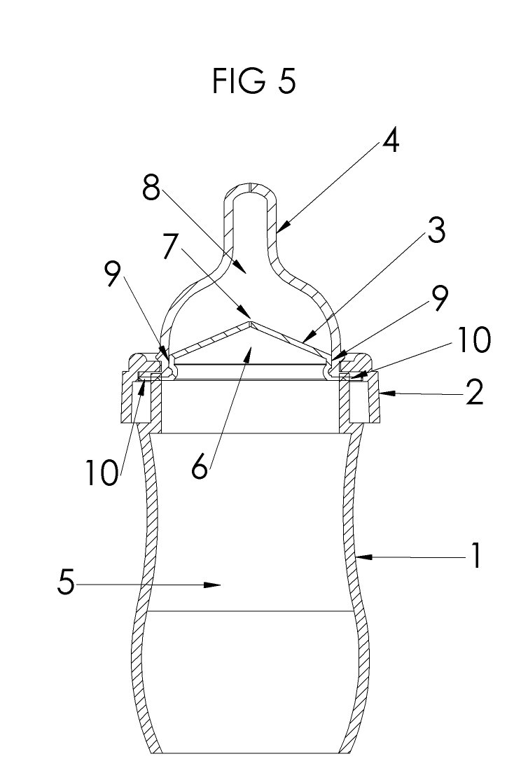

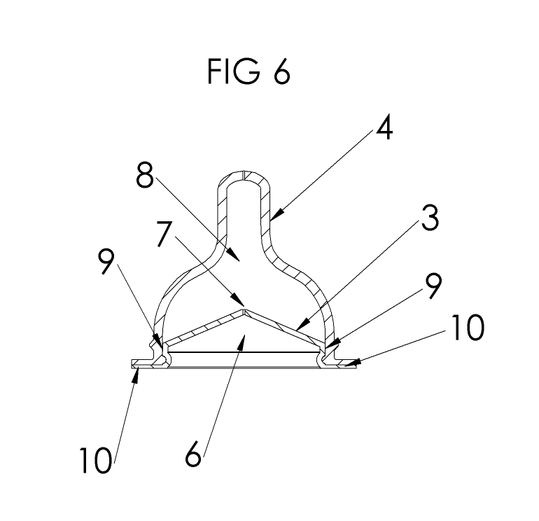

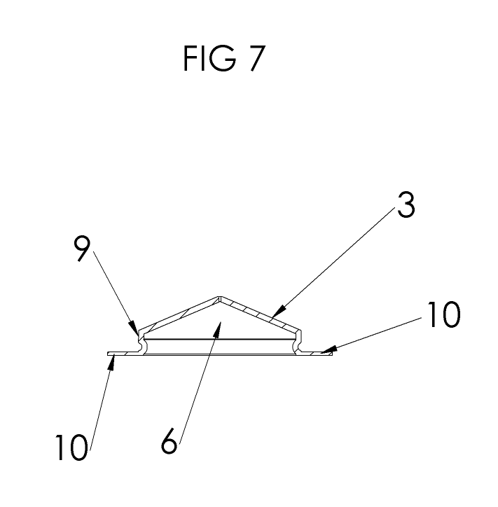

The present invention relates to a liquid medication dispensing device for mixing and administering medication(s) with formula, breast milk or other liquid to an infant. The dispensing device of the present invention may comprise a plastic cone shaped or duckbill shaped insert 3 (shown in FIG. 1-7). The insert 3 makes mechanical contact on the sealing rim 9 (shown in FIG. 1-7) with a feeding nipple 4 (shown in FIGS. 1,2,3,5,6) when inserted into said feeding nipple 4 such that the insert forms a liquid seal along the full perimeter of the insert 3 and the nipple 4 and is assisted by the seating flange 10 (shown in FIGS. 5,6,7). The dispensing device further comprises: a) an inlet 6 (shown in FIG. 1-7) in flow communication through a port 7 (shown in FIG. 1-7) with a feeding bottle 1 (shown in FIGS. 1,3,5) when bottle 1 is turned upside down, as in when used during feeding an infant; b) an outlet 7 (shown in FIG. 1-7) in flow communication with the inlet 6 when bottle 1 is turned upside down, said inlet 6 having larger diameter than said outlet 7 so that formula or breast milk can flow from said bottle 1 to said inlet 6 and to said outlet 7 when turned upside down, as in when used during feeding an infant.

When the dispensing device is in mechanical contact on the sealing rim 9 with a nipple 4, said inserted device forms two chambers, (an upper chamber 8 (shown in FIGS. 1,2,3,5,6) and lower chamber 5 (shown in FIGS. 1,3,5) in said dispensing device. The upper chamber 8 and lower chamber 5 are in flow communication with each other by means of the inlet 6 and outlet 7 of the dispensing device when bottle 1 is turned upside down as in when used during feeding an infant. The upper chamber 8 is in flow communication with the hole in the nipple when the nipple is turned upside down as in when used for feeding an infant.

Medication is placed into the upper chamber 8 of the nipple 4 such that the medication(s) is contained in the upper chamber 8 of the dispensing device and nipple 4. The medication(s) can be placed into the nipple 4 first with the device being inserted second, or the medication(s) can be inserted into the upper chamber 8 through the outlet port 7. Either way, the medication(s) is contained into the upper chamber 8 such that it is not in flow communication with the lower chamber 5 when the bottle 1 in an upright position. The medication is said to not be in flow communication because the medication cannot flow from the upper chamber 8 into the lower chamber 5 of the device.

The nipple 4 with device inserted is attached to the bottle top 2 (shown in FIGS. 1,3,5) and attached to an infant feeding bottle 1. The bottle 1 contains formula or breast milk. The formula or breast milk is contained in the lower chamber 5 of the device and is in flow communication of the inlet 6 when the bottle 1 is turned upside down during feeding. The formula is said to be in flow communication because it can flow from the lower chamber 5 through the inlet 6 and outlet 7 into the upper chamber 8. Prior to feeding, formula or breast milk can be allowed to flow into the upper chamber 8 so that it mixes with the medication(s) contained in the upper chamber 8 when lower chamber 5 is in flow communication with upper chamber 8.

1. A liquid medication dispenser including a standard feeding bottle and nipple adapted to deliver a mixture of a palatable beverage and a liquid medication, comprising: an insert in contact with the nipple achieving a liquid-tight seal between the insert and the nipple and forming an upper chamber substantially within the nipple and a lower chamber substantially within the bottle, the insert having a port allowing fluid communication between the upper chamber and lower chamber.

2. The liquid medication dispenser of claim 1 wherein the port comprises a cylindrical member elongated along an axis running from an inlet proximate to the lower chamber to an outlet proximate to the upper chamber.

3. The liquid medication dispenser of claim 1 wherein the port comprises a conical member elongated along an axis running from an inlet proximate to the lower chamber to an outlet proximate to the upper chamber.

4. The liquid medication dispenser of claim 3 wherein the inlet is larger than the outlet.

5. The liquid medication dispenser of claim 1 wherein the port comprises an elongated tubular member extending into the upper chamber thereby forming a medication reservoir within the upper chamber.

6. The liquid medication dispenser of claim 5 wherein the medication reservoir has a volume of at least one teaspoon.

7. The insert of claim 1 wherein the insert is made from a class of polymers in the poly olefin family.

8. The insert of claim 1 wherein the insert is made from the class of polymers in the thermoplastic elastomer family.

9. The insert of claim 1 wherein the insert is a duckbill.

10. The insert of claim 1 wherein the insert is made from the class of polymers in the silicone family.

11. The insert of claim 1 wherein the insert is manufactured using liquid injection molding.

12. The insert of claim 9 wherein the outlet port is a slit.

13. The insert of claim 12 wherein the slit is in mechanical contact when fluid flows in one direction and is not in mechanical contact when fluid flows from the opposite direction.

14. An insert adapted to allow a standard feeding bottle and nipple to be used as a liquid medication dispenser by forming an upper chamber substantially within the nipple for holding liquid medication and a lower chamber substantially within the bottle for holding a beverage, the insert comprising: a circular sealing ridge having an outer diameter substantially equal to an inner diameter of the nipple; and and a port disposed radially inward from the sealing ridge.

15. The insert of claim 12 wherein the port comprises a cylindrical member elongated along an axis running from an inlet proximate to the lower chamber to an outlet proximate to the upper chamber.

16. The insert of claim 12 wherein the port comprises a conical member elongated along an axis running from an inlet proximate to the lower chamber to an outlet proximate to the upper chamber.

17. The insert of claim 14 wherein the inlet is larger than the outlet.

18. The liquid medication dispenser of claim 12 wherein the port comprises an elongated tubular member extending into the upper chamber thereby forming a medication reservoir within the upper chamber.

19. The liquid medication dispenser of claim 16 wherein the medication reservoir has a volume of at least one teaspoon.

20. The insert of claim 12 further comprising a seating rim integral with the sealing ridge and extending radially outward from the sealing ridge.

21. The insert of claim 12 wherein the insert is made from a class of polymers in the poly olefin family.

22. The insert of claim 12 wherein the insert is made from the class of polymers in the thermoplastic elastomer family.

23. The insert of claim 12 wherein the insert is a duckbill.

24. The insert of claim 12 wherein the insert is made from the class of polymers in the silicone family.

25. The insert of claim 12 wherein the insert is manufactured using liquid injection molding.

26. The insert of claim 23 wherein the outlet port is a slit.

27. The insert of claim 26 wherein the slit is in mechanical contact when fluid flows in one direction and is not in mechanical contact when fluid flows from the opposite direction
